(19) United States
(12) Patent Application Publication
(10) Pub. No.: US 2025/0232383 A1
(43) Pub. Date: Jul. 17, 2025

(54) METHOD AND SYSTEM FOR PREDICTING THE MOST LIKELY SUPPLEMENTARY MEDICAL SERVICES FOR A GIVEN PRIMARY SERVICE BY IDENTIFYING PATTERNS BETWEEN CO-OCCURRING BILLED SUPPLEMENTARY SERVICES IN HISTORICAL CLAIMS DATA

(71) Applicant: Humana Inc., Louisville, KY (US)

(72) Inventors: Shipra Arjun, Littleton, MA (US); Matthew Alan Coddington, Louisville, KY (US); Zachary Gabbert, Charlestown, MA (US); John Andrew Kattirtzi, Monroe, CT (US); Chulmin Lee, Middleton, MA (US); Michael Benjamin Kolbeck, Boston, MA (US); Sneha Roy, Boston, MA (US)

(21) Appl. No.: 19/097,966

(22) Filed: Apr. 2, 2025

Related U.S. Application Data
(63) Continuation of application No. 17/866,181, filed on Jul. 15, 2022.

(51) Int. Cl. G06Q 40/08; G06Q 30/04

(52) U.S. Cl. CPC G06Q 40/08; G06Q 30/04

(57) ABSTRACT

A method and system for determining or predicting the most commonly billed supplementary codes or medical services for each unique primary CPT code or service by identifying patterns between co-occurring billed supplementary services in historical claims data. The accuracy of the predictions is scored by applying a similarity index, and an accuracy score is provided for each prediction.

### BACKGROUND OF THE INVENTIVE FIELD

This application is a continuation of U.S. application Ser. No. 17/866,181 filed Jul. 15, 2022; the disclosures of each of the foregoing being hereby incorporated by reference in their entireties.

The present invention is directed to determining or predicting the most commonly billed supplementary codes or medical services for each unique combination of primary CPT code or service and treatment avenue by identifying patterns between co-occurring billed supplementary services in historical claims data.

Transparency in health care systems has always been limited. Patients rarely understand which procedures they will be billed for. This makes it difficult for patients to financially plan for medical procedures, driving them to seek reactive rather than proactive care. This eventually leads to higher costs of care and more uncertainty about what additional procedures will be needed.

The present invention aims to provide insight into frequently co-occurring procedures by allowing healthcare consumers to better account for upcoming care, and shifting habits towards proactive care. This is a win for both consumers and payers and increases the efficiency of overall healthcare consumption.

Current Procedural Terminology (CPT) codes are codes that health care professionals use to uniformly identify or represent medical services to track which procedures a patient has or will receive. CPT codes identify medical procedures, clinical laboratory services, and/or emerging technologies and services. Data analysis was performed on claims data, and it was determined that CPT codes are rarely billed independent of other CPT codes for each patient visit. Providers also frequently bill for common sets of procedures that are done at the same time—a “buy in bulk” deal negotiated directly with payers known as “bundles”. The present invention includes the use of machine learning and statistical analysis to identify patterns in these CPT codes, and particularly to billed supplementary CPT codes (codes representing other services provided when rendering the primary service to the patient) to find frequently co-occurring or bundled medical procedures or services.

While one overall goal of the present invention is price transparency, the determination of co-occurring procedures is important for various reasons. First, it can be used to accurately identify components of a total bill an individual is likely to receive, enabling more granular price look ups. Additionally, identifying co-occurring procedures enables future targeted research into common bundle-adjusted pricing. The present invention provides quality and accuracy measures “out of the box”, removing uncertainty and subjectivity from the bundle identification process.

### SUMMARY OF THE GENERAL INVENTIVE CONCEPT

In one embodiment of the invention, the invention is comprised of: a method of predicting a set or bundle of medical services to be rendered to patients, the method comprising the steps of:
collecting historical claims data for a pool of patients for a predetermined time period and storing the historical claims data in a memory storage device;
grouping the historical claims data into treatment visits by patient;
creating a first table of data where each row of the first table of data corresponds to a particular treatment visit for a particular patient, wherein the first table of data is comprised of a primary CPT code or service for each particular treatment visit, billed supplementary CPT codes or services associated with each particular treatment visit, and a treatment avenue associated with each particular treatment visit;
establishing a plurality of unique combinations comprising one primary CPT code or service with one treatment avenue;
determining associated sets of billed supplementary CPT codes or services for each unique combination found in the first table of data;
identifying patterns, using a processing system, between co-occurring billed supplementary codes or services for a particular unique combination;
determining a list of predicted supplementary CPT codes or services for the particular unique combination, the list representing a most likely set or bundle of medical services to be rendered for the particular unique combination;
taking a predetermined number of the associated sets of billed supplementary CPT codes or services for the particular unique combination to be used as a test set;
comparing the list of predicted supplementary CPT codes or services for the particular unique combination with supplementary billed CPT codes or services for each of the associated sets of billed supplementary CPT codes of the test set;
scoring the accuracy of the predictions for the particular unique combination by applying a similarity index; and
determining an accuracy score for the particular unique combination.

In one embodiment of the invention, the method is further comprised of the steps of:
identifying the patterns by applying a Frequent Pattern Growth algorithm, to the associated sets of billed supplementary CPT codes or services for each unique combination;
using a plurality of trees to track and count the co-occurring billed supplementary CPT codes or services for each unique combination; and
using the patterns identified by the FP Growth algorithm to predict the supplementary CPT codes or services for the particular combination.

The foregoing and other features and advantages of the present invention will be apparent from the following more detailed description of the particular embodiments, as illustrated in the accompanying drawings.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates one embodiment of the pre-processing of the claims data before inputting of the data into the modeling processes of the present invention.

FIG. 2 illustrates one embodiment of the inputs provided into the modeling processes of the present invention.

FIG. 3 illustrates one embodiment of producing trained models of the present invention by identifying patterns in the co-occurring billed services.

FIG. 4 illustrates one embodiment of tuning the hyperparameters of the models to optimize the Jaccard similarity.

FIG. 5 illustrates one embodiment of applying the selected trained models to the test set to produce the final bundle predictions and Jaccard similarity scores.

### DETAILED DESCRIPTION OF EXEMPLARY EMBODIMENT(S)

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

The present invention involves a processing system that has access to millions of historical claims. In the preferred embodiment, not all this data is compared directly. There are claims from different populations including Medicare, commercial, and associates. Each population's health needs are fundamentally different, as each vary significantly in overall health. One example iteration of the model exclusively uses associates' claims data as it is comprised of enough claims volume and variation to yield actionable patterns.

In order to further narrow the scope for this first example iteration, associates' claims data was filtered to include only the following:
1. In network claims: to have full access to all claims related to a patient's visit.
2. Out-patient claims: to simplify the bundling process to use visits rather than entire episodes of care.
3. Specific procedures: to focus on the “shoppable 70” procedures, specified by the Center of Medicare Services (CMS) price transparency mandate. Of the 70 procedures, 55 procedures that had enough data to enable the model of the present invention to make meaningful predictions were used in the example embodiment.

### Pre-Processing

Large insurance companies often have automated processes to extract data from claims and store into database tables. The present invention performs significant pre-processing on the database table that contains completed and adjudicated historical claims records over many years for different populations (e.g., associates between 2016-2017). This table will hereby be referred to as Raw Claims Table.

The Raw Claims Table is supplemented by joining with various reference tables that are available to the present invention. The reference tables used are Provider Details Table, Place of Treatment Details Table, Procedure Categories Table, and the American Medical Association's (AMA's) Procedure Descriptions Table. These tables provide details of the provider, the place of treatment, and descriptions of the procedures. The Raw Claims Table is preferably joined to the reference tables on shared columns. For example, the provider code is used to join on the Provider Details Table, place of treatment code is used to join on the Place of Treatment Details Table, and procedure code is used to join on the Procedure Categories Table and AMA's Procedures Description Table. This new table is called the Extended Claims Table.

The Extended Claims Table contains columns that describe the place of treatment and provider type. In this present invention, the term “treatment avenue” is defined to describe either a place of treatment or a provider type, depending on which is most understandable to everyday users. For example, if a patient visited the emergency room for chest pain, the treatment avenue would be “emergency room”. However, if they attended a scheduled specialist visit at the hospital, the treatment avenue would be “cardiologist”. The columns describing the place of treatment and provider type are combined to generate a new treatment avenue column in the Extended Claims Table.

To investigate the claims associated with a single visit on a single day, all the rows in the Extended Claims Table corresponding to a specific person (characterized by a person ID) on a specific service date were grouped together. In this embodiment, any visits that consist of out-of-network claims or claims that span multiple days were removed, focusing the model's scope on out-patient, in-network claims (i.e., to obtain the appropriate claims set for modeling).

From a patient's perspective, there are many CPT codes for seemingly similar procedures. While this may be clear to healthcare providers, it is confusing to patients who want to know which additional procedures would be involved for a specific visit. For example, there are over 30 CPT codes for stitches depending on the site, size, and severity. A patient may be interested in knowing which supplemental procedures will be performed when they receive stitches, but would not be able to give the specific CPT code of interest. In one embodiment of the present invention the CPT codes corresponding to similar procedures are mapped to the CPT code that occurs most often, hereby defined as the Primary CPT code. “Primary CPT code” is defined as the code that represents the main procedure or service that the patient is to be treated for or admitted to the hospital for (for that particular visit).

The final output of the pre-processing results are in the Procedure Bundles Table. Each row in this table corresponds to a specific person's visit on a single day. The rows contain the details of the visit such as the procedure the patient went in for, the list of supplementary procedures that occurred, and the treatment avenue.

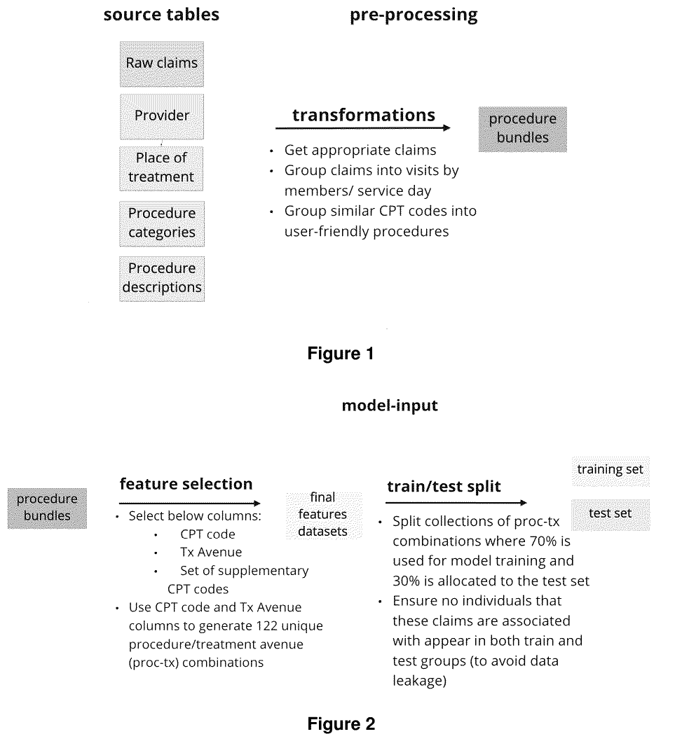

FIG. 1 illustrates one embodiment of the pre-processing of the claims data before inputting of the data into the modeling processes. A Raw Claims Table is joined onto the Provider Details, Place of Treatment Details, Procedure Categories, and AMA's Procedure Descriptions Tables to give the Extended Claims Table. The Extended Claims Table is transformed as described above to produce the Procedure Bundles Table.

### Model Input

The pre-processing described above allows for the analysis of patient visits in different ways. In one embodiment, the modeling process takes three columns of the Procedure Bundles Table as inputs: the primary CPT code, the treatment avenue, and the set of supplementary billed CPT codes. For example, the primary CPT code is combined with the treatment avenue, yielding 122 unique procedure/treatment avenue (proc-tx) combinations. The 122 specific models are then trained to find the most common supplementary billed CPT codes for each proc-tx. This is done, for example, by applying the Frequent Pattern (FP) Growth algorithm to the associated sets of supplementary billed CPT codes for a proc-tx.

In one embodiment of the invention, to evaluate the models, not all visits are used for training. For example, the collection of visits for a given proc-tx are split into training and test sets in an approximate 70:30 ratio respectively and ensure that no individual appears in both sets. The predicted CPT codes are compared with the actual supplementary billed CPT codes in each visit in the corresponding test set and the model is scored using Jaccard similarity processing, for example.

FIG. 2 illustrates one embodiment of the inputs provided into the modeling processes of the present invention. Three columns from the Procedure Bundles Table are selected as inputs to the model and are referred to as final features. The final features are split row-wise into two groups: train set and test set.

### Model Algorithm

Association rule mining can be used to identify patterns between frequent, co-occurring supplementary billed CPT codes. In one embodiment, FP Growth, an association rules algorithm is applied. This algorithm uses trees to track and count co-occurring CPT codes and is more efficient because of its improved performance on distributed systems compared with the more widely used a priori algorithm. Association rule mining is often used in market basket analysis to understand customer shopping habits and product purchases. For example, by analyzing many customers' grocery items, the algorithm can predict that if a customer purchases beer they are also likely to purchase wine and cheese. This example approach of the present invention uses the patterns identified by FP Growth as predictions of the supplementary billed CPT codes a patient would receive for a given proc-tx.

The FP Growth algorithm may be applied according to the present invention as follows:
For every CPT code in the data, the frequency of each item is calculated.
Items with frequencies below the minimum support (or frequency threshold) are removed.
For each visit, the CPT codes are sorted on frequency.
The FP tree is created by iterating through each visit and assigning a tree node to a procedure code and its associated frequency.
As the tree grows in height and diameter, the associated frequencies are also updated.
Combinations of CPT codes below the minimum confidence (or threshold) are removed.
The remaining combinations of CPT codes are collected to provide the prediction.

Two hyperparameters of the FP Growth algorithm are minimum support and minimum confidence. The minimum support is a ratio describing the number of times a procedure is seen compared to the total number of examples in the training data. The frequency must be higher than the minimum support to be considered in the FP tree.

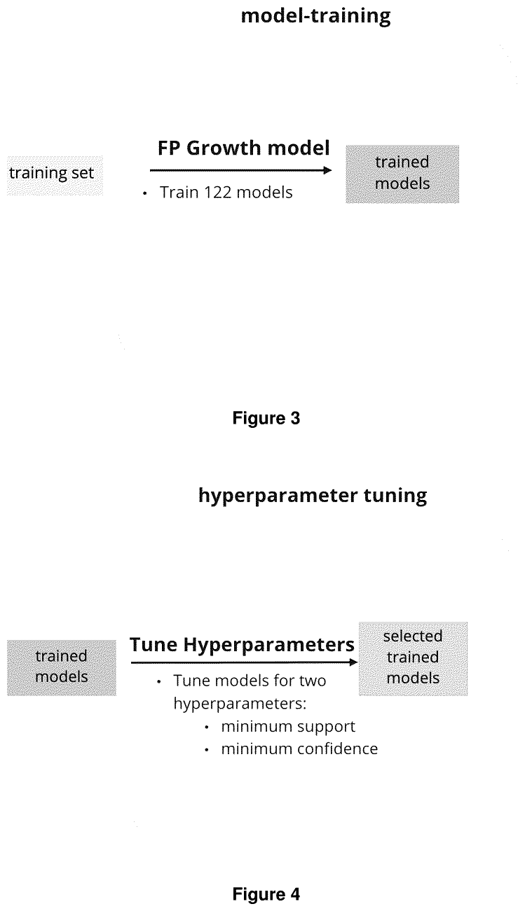

The other hyperparameter, minimum confidence, is a ratio describing the number of times that a particular pair of procedures (A and B) must be seen, compared to the total number of times one of the procedures (A) is seen. It answers the question “is this relationship between procedures frequent enough to be used in predictions”. The frequency of any particular pair must be higher than the minimum confidence to be kept in the FP tree. FIG. 3 illustrates one embodiment of producing trained models of the present invention by identifying patterns in the co-occurring billed services. In this example embodiment, the FP Growth algorithm is applied to the training set to produce trained models.

### Model Evaluation and Hyperparameter Selection

In order to determine the most appropriate hyperparameters, the models were evaluated using the Jaccard similarity. This score describes the similarity between the predicted CPT codes and the actual supplementary CPT codes for a given proc-tx. It is defined as:

$$Jaccard similarity = \frac{\# true positives}{\# true positives + \# false positives + \# false negatives}$$

### Where:

True positives: the predicted CPT code is one of the actual supplementary CPT codes.
False positives: the predicted CPT code is not one of the actual supplementary CPT codes.
False negatives: one of the actual supplementary CPT codes was not one of the predicted CPT codes.

In this example embodiment, a Jaccard similarity is calculated for every visit in the test set for a given proc-tx. To get a single score for each model, the mean Jaccard Similarity is used. Choosing different hyperparameters may yield a different mean Jaccard similarity for a model. To find the most appropriate hyperparameters, a grid search is performed over a uniform search space of continuous numbers from 0.1 to 0.9. By using Bayesian optimization, hyperparameters from the search space are sequentially tried to find the set of parameters that produces the best performing model. This automatically selects and saves an optimal model for each of the 122 proc-tx combinations. FIG. 4 illustrates one embodiment of tuning the hyperparameters of the models to optimize the Jaccard similarity. This process yields the final selected trained models.

### Model Output

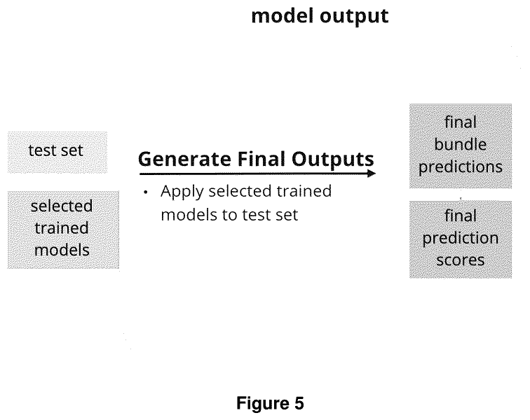

Once the optimal model for each proc-tx combination has been trained using the “training” partition of our dataset, the “test” partition is used to generate the model's output and evaluated its performance. For a given proc-tx combination, the predicted procedure bundle is compared with the actual procedures billed at every visit in the test set for that model. This provides a Jaccard similarity score for each visit of a model. The mean of these scores is then used to determine the model's overall score. The model's overall score is saved along with the predicted procedure bundle. Ultimately, in this example embodiment, there are 122 models—each with its own predicted procedure bundle and a corresponding score. FIG. 5 illustrates one embodiment of applying the selected trained models to the test set to produce the final bundle predictions and Jaccard similarity scores.

### API

An API service may be created to make the model widely available and internally accessible to insurance agents for example. To enable internal teams to hit the model, the service may be deployed to the participating network. To do this, data from the model training phase is gathered and stored in an internal datastore co-located with the service. The service then pulls from and displays to secure users the following model output data and metadata using the corresponding URL structure:
1. /procedures—procedures and their corresponding CPT codes.
2. /avenues/{proc_cd}—available treatment avenues per unique CPT code.
3. /avenues/{proc_cd}/count—count of available treatment avenues per unique CPT code.
4. /bundle?procedure={proc_cd}&avenue={tx_avenue}—frequently bundled procedures for a given proc-tx combination.
5. /bundle?procedure={proc_cd}—all frequently bundled procedures for each available avenue of a given CPT code.

For all endpoints which return a bundle, the outputs include both the predicted procedure codes and the Jaccard similarity score corresponding to the proc-tx's model. The score is a valuable addition to the outputs because it communicates to the user a level of confidence in each prediction. This allows consumers of the API to build potential experiences that reflect directly to users the accuracy of the displayed predictions.

### OTHER EMBODIMENTS

The first iteration or embodiment of the model focuses on associates' data for in-network, out-patient claims and is limited to 55 specific procedures. There are several changes that could be made to further improve the model's accuracy and provide additional functionality. For example, some of the possibilities include:
1. Include multi-day procedures.
2. Define episode-of-care bundles.
3. Expand to our other populations.
4. Investigate possible biases in the data.
5. Expand the number of procedures.
6. Expand to include pharmacy, dental, and vision.
7. Connect the bundle model with associated costs.
8. Supply insights about the provider, including costs, procedures performed, and ratings.
9. Supplement associate claims with data from other payers to improve coverage of available data.
10. Personalize procedure and cost predictions using a member's demographic, regional, and plan data.

### Other Use Cases or Applications

The present invention allows patients to plan for their financial and physical well-being. By comparing bundles at different treatment avenues, patients are encouraged to take proactive and not reactive care. Integrating the models into a mobile app would give members visibility into procedure bundles and their associated costs. The models could also be connected to internal corporate health insurance apps used by customer service agents or care teams to allow representatives to assist members of the insurance plan.

In addition to the primary uses of our models, the present invention can be applied to other potential use cases that are described below:
1. Educating patients on their healthcare needs to improve patient-doctor relationships.
2. Enable prospective members to obtain the most appropriate healthcare plan for them.
3. Facilitate members to choose providers with the highest rated billing practices.
4. Guide members to use episode of care programs built by their insurance companies.
5. Create insurance plans with more competitive benefits.
6. Allow payers to negotiate rates for bundles that provide the most value to members.
7. Assist insurance companies to detect fraudulent claims.
8. Investigate regional and demographic differences amongst procedure bundles.
9. Analyze healthcare cost variability for different procedure bundles at different treatment avenues.
10. Create policies to avoid bias and discrepancies of procedures performed and costs charged.
11. Incentivize providers to follow more standard practices and policies.
12. Identify opportunities for manufacturers to develop multi-purpose medical devices.

While certain embodiments of the present invention are described in detail above, the scope of the invention is not to be considered limited by such disclosure, and modifications are possible without departing from the spirit of the invention as evidenced by the following claims:

What is claimed is:

1. A method of preprocessing and training a machine learning model to predict the most commonly billed supplementary Current Procedural Terminology (CPT) codes for a combination of a primary CPT code and a treatment avenue comprising the steps of:
preprocessing a set of historical claims data, the step of preprocessing the set of historical claims data further comprising the steps of:
a. extracting relevant data from the set of historical claims data to include claims associated with a treatment visit on a single day;
b. for each particular treatment visit, combining a primary CPT code that represents the main procedure or service provided, a list of supplementary CPT codes, and a treatment avenue to compile a model input data set, wherein the treatment avenue is a place of treatment or a provider type;
splitting the model input data set into a training set and a testing set to identify patterns in the training set;
training at least one model with the training set of the model input data set; and
training the at least one model so that the at least one model can predict a set of commonly billed supplementary CPT codes from an inputted primary CPT code and an inputted treatment avenue.

2. The method of claim 1, wherein the at least one model is trained using the Frequent Pattern (FP) Growth algorithm to identify patterns between frequent, co-occurring supplementary CPT codes.

3. The method of claim 2, further comprising the steps of:
using trees to track and count the frequent, co-occurring supplementary codes to improve performance on distributed systems.

4. The method of claim 1, further comprising the steps of:
determining the frequency for every CPT code in the training set;
removing CPT codes with frequencies below a predetermined frequency threshold are removed;
assigning a tree node to each CPT code remaining and its associated frequency;
updating the associated frequencies as the at least one model grows;
removing combinations of CPT codes below a minimum confidence threshold.

5. The method of claim 6, wherein the minimum confidence threshold is a ratio describing the number of times that a particular pair of procedures must be seen, compared to the total number of times one of the procedures of the pair of procedures is seen.

6. The method of claim 1, further comprising the steps of:
determining a similarity score for each particular treatment visit in the testing set by determining the similarity between predicted supplementary CPT codes and actual supplementary CPT codes for each particular treatment visit in the testing set.

7. The method of claim 6, further comprising the step of:
determining the most appropriate parameters by using optimization;
selecting the optimal model by selecting the set of parameters that produces the best results.

8. The method of claim 6, further comprising the steps of:
inputting combinations of one primary CPT code with one treatment avenue into the trained at least one model;
predicting at least one supplementary CPT code for each of the inputted combinations using the trained at least one model; and
outputting a similarity score that represents a level of confidence for each prediction.

9. The method of claim 1, further comprising the steps of:
including multi-day procedures into the model input data set;
connecting the model input data set with associated costs; and
personalizing procedure and cost predictions using member demographic, regional and plan data.

10. The method of claim 1, further comprising the steps of:
i. determining a frequency that each of the supplementary CPT codes appear in the list of supplementary CPT codes for each unique combination;
ii. comparing the frequency of each of the supplementary CPT codes to a frequency threshold;
iii. removing supplementary CPT codes if the frequency is below a predetermined minimum frequency threshold;
iv. determining a number of times, a particular pair of supplementary CPT codes is found together compared to the number of times one of the supplementary CPT codes of the particular pair is found; and
v. removing the particular pair of supplementary CPT codes if the number of times a particular pair of supplementary CPT codes is found is not more than a minimum confidence threshold.

11. The method of claim 1, further comprising the step of:
preparing a personalized cost prediction for a first particular patient using the first particular patient's demographic data and the list of predicted supplementary CPT code generated by the at least one model.

12. The method of claim 11, further comprising the step of:
identifying potential fraudulent billing by comparing the personalized predicted cost with an actual billed amount; and
creating an alert when the predicted cost is lower than the actual billed amount.

13. The method of claim 1, further comprising the step of:
identifying potential fraudulent billing by comparing a list of predicted supplementary CPT codes generated by the at least one model with a list of billed supplementary CPT codes from an actual patient invoice to identify fraudulently billed supplementary CPT codes; and
creating an alert when the potential fraudulent billing is detected.

14. A method of preprocessing and training a machine learning model to predict the most commonly billed supplementary Current Procedural Terminology (CPT) codes for a combination of a primary CPT code and a treatment avenue comprising the steps of:
preprocessing a set of historical claims data, the step of preprocessing the set of historical claims data further comprising the steps of:
a. extracting relevant data from the set of historical claims data to include claims associated with a treatment visit on a single day;
b. for each particular treatment visit, combining a primary CPT code that represents the main procedure or service provided, a list of supplementary CPT codes, and a treatment avenue to compile a model input data set, wherein the treatment avenue is a place of treatment or a provider type;
splitting the model input data set into a training set and a testing set to identify patterns in the training set;
training at least one model with the training set of the model input data set;
training the at least one model so that the at least one model can predict a set of commonly billed supplementary CPT codes from an inputted primary CPT code and an inputted treatment avenue;
inputting combinations of one primary CPT code with one treatment avenue into the trained at least one model;
predicting at least one supplementary CPT code for each of the inputted combinations using the trained at least one model; and
outputting a similarity score that represents a level of confidence for each prediction.

15. The method of claim 14, further comprising the steps of:
determining the frequency for every CPT code in the training set;
removing CPT codes with frequencies below a predetermined frequency threshold are removed;
assigning a tree node to each CPT code remaining and its associated frequency;
updating the associated frequencies as the at least one model grows;
removing combinations of CPT codes below a minimum confidence threshold.

16. The method of claim 15, wherein the minimum confidence threshold is a ratio describing the number of times that a particular pair of procedures must be seen, compared to the total number of times one of the procedures of the pair of procedures is seen.

17. The method of claim 14, further comprising the steps of:
determining a similarity score for each particular treatment visit in the testing set by determining the similarity between predicted supplementary CPT codes and actual supplementary CPT codes for each particular treatment visit in the testing set.

18. The method of claim 14, further comprising the step of:
determining the most appropriate parameters by using optimization;
selecting the optimal model by selecting the set of parameters that produces the best results.

19. The method of claim 14, further comprising the step of:
preparing a personalized cost prediction for a first particular patient using the first particular patient's demographic data and the list of predicted supplementary CPT code generated by the at least one model.

20. The method of claim 19, further comprising the step of:
identifying potential fraudulent billing by comparing the personalized predicted cost with an actual billed amount; and
creating an alert when the predicted cost is lower than the actual billed amount.

21. The method of claim 14, further comprising the step of:
identifying potential fraudulent billing by comparing a list of predicted supplementary CPT codes generated by the at least one model with a list of billed supplementary CPT codes from an actual patient invoice to identify fraudulently billed supplementary CPT codes; and
creating an alert when the potential fraudulent billing is detected.

22. A method of preprocessing and training a machine learning model to predict the most commonly billed supplementary Current Procedural Terminology (CPT) codes for a combination of a primary CPT code and a treatment avenue comprising the steps of:
preprocessing a set of historical claims data, the step of preprocessing the set of historical claims data further comprising the steps of:
a. extracting relevant data from the set of historical claims data to include claims associated with a treatment visit on a single day;
b. for each particular treatment visit, combining a primary CPT code that represents the main procedure or service provided, a list of supplementary CPT codes, and a treatment avenue to compile a model input data set, wherein the treatment avenue is a place of treatment or a provider type;
splitting the model input data set into a training set and a testing set to identify patterns in the training set;
training at least one model with the training set of the model input data set;
training the at least one model so that the at least one model can predict a set of commonly billed supplementary CPT codes from an inputted primary CPT code and an inputted treatment avenue;
inputting combinations of one primary CPT code with one treatment avenue into the trained at least one model;
predicting at least one supplementary CPT code for each of the inputted combinations using the trained at least one model;
outputting a similarity score that represents a level of confidence for each prediction;
preparing a personalized cost prediction for a first particular patient using the first particular patient's demographic data and the list of predicted supplementary CPT code generated by the at least one model;
identifying potential fraudulent billing by comparing the personalized predicted cost with an actual billed amount; and
creating an alert when the predicted cost is lower than the actual billed amount.
